(19) United States
(12) Patent Application Publication
(10) Pub. No.: US 2010/0270179 A1
(43) Pub. Date: Oct. 28, 2010

(54) METHOD FOR MEASURING PH VALUE OF SAMPLE SOLUTION AND SYSTEM THEREOF

(75) Inventors: Jung-Chuan CHOU, YUNLIN COUNTY (TW); Yi-Hung LIAO, YUNLIN COUNTY (TW)

Correspondence Address: QUINTERO LAW OFFICE, PC, 615 Hampton Dr, Suite A202, Venice, CA, 90291, US

(73) Assignee: NATIONAL YUNLIN UNIVERSITY OF SCIENCE AND TECHNOLOGY, YUNLIN (TW)

(21) Appl. No.: 12/553,809

(22) Filed: Sep. 3, 2009

(30) Foreign Application Priority Data
Apr. 28, 2009 (TW) TW098113995

(51) Int. Cl. G01N 27/26

(52) U.S. Cl. 205/787.5; 204/406

(57) ABSTRACT

The invention provides a method for measuring a pH value of a sample solution, which is performed by a pH sensing device, including: providing a pH sensing device and a sample solution, wherein the pH sensing device includes a pH sensor array, and the pH sensor array comprises m pH sensors, and m is an integer greater than 1; measuring the sample solution with the pH sensor array for n times, wherein n is an integer greater than 1, n measurement values are generated, each pH sensor generates a measurement value for each measurement, and the total amount of measurement values generated is n×m; and generating a pH value of the sample solution by all of the measurement values generated by the pH sensor array.

### CROSS REFERENCE TO RELATED APPLICATIONS

This Application claims priority of Taiwan Patent Application No. 098113995, filed on Apr. 28, 2009, the entirety of which is incorporated by reference herein.

### BACKGROUND OF THE INVENTION

1. Field of the Invention

The present invention relates to a method for measuring a pH value of a sample solution, and in particular relates to a method for measuring a pH value of a sample solution, which combines use of a pH sensor array with a weighted data fusion calculation. The measurement errors resulted from fail or instability of a single device may be prevented by using the method of the invention.

2. Description of the Related Art

Ion concentration (or pH value) of a sample solution may be obtained by a sensing membrane. Specifically, surface voltage of a sensing membrane changes due to the adhesive bonding of hydrogen ions and hydroxyl ions. Determining the pH value of a sample solution is important for certain types of clinical diagnosis, waste water monitoring and environmental water pollution monitoring. Operational stability and accuracy of pH value systems are important for long term pH value monitoring.

However, often, a single pH value system is insufficient in providing stable pH value readings, and may breakdown causing measurement errors.

Zhou disclosed applying self-adaptive sensor weighted data fusion in strain detection (Y. Zhou, H. S. Li, and Y. Z Ding, “Self-adaptive sensor weighted data fusion in strain detection”, in Proc. Eighth International Conference on Electronic Measurement and Instruments, pp. 55-58, 2007.).

Gao et al disclosed a data fusion method for sample mean random weighting estimation (S. Gao, Z. Feng, and H. Li, “The research of data fusion method for sample mean random weighting estimation”, in Proc. 2006 IEEE International Conference on Information Acquisition, Weihai, Shandong, China, Aug. 20-23, pp. 584-588, 2006.)

### BRIEF SUMMARY OF THE INVENTION

The invention provides a method for measuring a pH value of a sample solution, which is performed by a pH sensing device, comprising: providing a pH sensing device and a sample solution, wherein the pH sensing device comprises a pH sensor array, and the pH sensor array comprises m pH sensors, and m is an integer greater than 1; measuring the sample solution with the pH sensor array for n times, wherein n is an integer greater than 1, n measurement values are generated, each pH sensor generates a measurement value for each measurement, and the total amount of measurement values generated is n×m; and generating a pH value of the sample solution by all of the measurement values generated by the pH sensor array.

The invention also provides a pH value measurement system, comprising: a pH sensing device, comprising: a pH sensor array comprising a plurality of pH sensors, wherein a sample solution is measured with the pH sensor array for n times, and n is an integer greater than 1, and each pH sensor generates a measurement value for each measurement and each pH sensor generates n signals; a readout circuit module coupled to the pH sensor array for receiving the n signals generated by each pH sensor; and a reference electrode coupled to the readout circuit module for providing a stable voltage; an data acquisition module coupled to the readout circuit module for converting the n signals generated by each pH sensor into n measurement values measured by each pH sensor; and a weighted data fusion calculation module coupled to the data acquisition module for performing a weighted data fusion calculation with all of the measurement values converted by the data acquisition module to generate a pH value of the sample solution.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 shows a cross section of a ruthenium dioxide pH sensor of the invention;

FIG. 2 shows a schematic view of a pH value measurement system of one embodiment of the invention;

FIG. 3 shows a schematic view of a pH value measurement system of another embodiment of the invention;

FIG. 4 shows the sensitivity test result for a sensor array measuring the different sample solutions with different pH values;

FIG. 5a shows the mean and standard deviation of the measurement values measured by respective single sensors by using a ruthenium dioxide sensor array to measure wine;

FIG. 5b shows the mean and standard deviation of the measurement values measured by respective single sensors by using a ruthenium dioxide sensor array to measure coca cola;

FIG. 5c shows the mean and standard deviation of the measurement values measured by respective single sensors by using a ruthenium dioxide sensor array to measure an alkaline water drink;

FIG. 6 shows the mean values of each of the sensor measurements of wine by a ruthenium dioxide sensor array and the results from the average data fusion calculation and weighted data fusion calculation of the sensor measurements;

FIG. 7 shows the mean values of each of the sensor measurements of coca cola by a ruthenium dioxide sensor array and the results from the average data fusion calculation and weighted data fusion calculation of the sensor measurements;

FIG. 8 shows the mean values of each of the sensor measurements of an alkaline water drink by a ruthenium dioxide sensor array and the results from the average data fusion calculation and weighted data fusion calculation of the sensor measurements; and

FIG. 9 shows the result of the average data fusion calculation and weighted data fusion calculation of the sensor measurements by a ruthenium dioxide sensor array and pH values measured by a pH meter of wine, coca cola and an alkaline water drink.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The method for measuring a pH value of a sample solution is detailed in the following.

First, a pH sensing device and a sample solution are provided, wherein the pH sensing device may comprise a pH sensor array. The pH sensor array may comprise m pH sensors and m is an integer greater than 1, such as 2, 4 or 8.

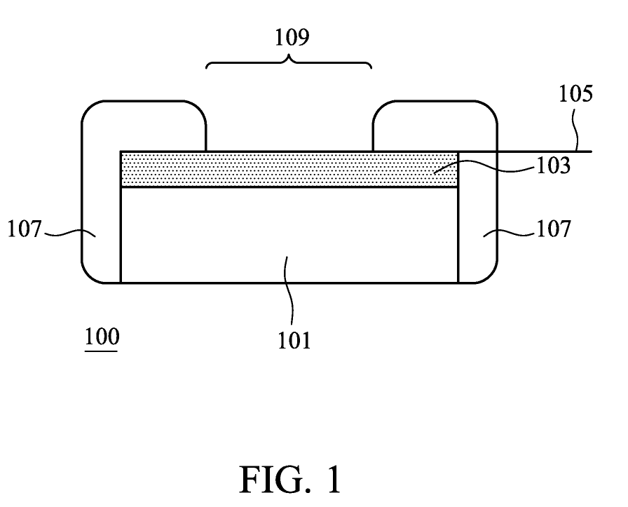

In one embodiment, the pH sensor may comprise a ruthenium dioxide pH sensor. As FIG. 1 shown, in one embodiment, a ruthenium dioxide pH sensor 100 may comprise a substrate 101, a ruthenium dioxide layer 103, a metal wire 105, and a protective layer 107. The ruthenium dioxide layer 103 on the substrate 101 forms a sensing region, the metal wire 105 fixed on a surface on the ruthenium dioxide layer 103 forms an external contact. The protective layer 107 is over the ruthenium dioxide layer 103 having an opening for a sensing window 109. The substrate may comprise a silicon substrate or a polyethylene terephthalate (PET) substrate. In one embodiment, the area of the sensing window 109 may be 2×2 mm².

Then, the sample is measured by the pH sensor array for n times and n is an integer greater than 1. After the sample is measured by the pH sensor array for n times, n measurement values are generated, each pH sensor generates a measurement value for each measurement, and the total amount of measurement values generated is n×m. Furthermore, a manner for measuring the sample solution with the pH sensor array may comprise contacting the sample solution with each pH sensor. In one embodiment, a manner for measuring the sample solution with the pH sensor array may comprise contacting the sample solution with the sensing window 109.

Finally, a pH value of the sample solution is generated by all of the measurement values generated by the pH sensor array. In one embodiment, a method for generating the pH value of the sample solution by all of the measurement values generated by the pH sensor array may comprise performing a weighted data fusion calculation of all of the measurement values generated by the pH sensor array to generate a weighted data fusion value, and the weighted data fusion value is the pH value of the sample solution. In one embodiment, the weighted data fusion calculation may comprise the following calculations.

First, a mean calculation is performed. A mean of the n measurement values generated by each pH sensor is calculated, respectively, wherein the total amount of means generated is m. Then, a standard deviation calculation is performed. A standard deviation of the n measurement values generated by each pH sensor is generate with the n measurement values generated by each pH sensor and the mean of the n measurement generated by each pH sensor, wherein the total amount of standard deviations generated is m. Next, a weighted factor calculation is performed. A weighted factor calculation corresponding to each pH sensor is generated with all the standard deviations, wherein the total amount of weighted factors generated is m. Finally, a weighted data fusion calculation is performed. A weighted value is generated by multiplying the mean of the n measurement values generated by the each pH sensor with the weighted factor corresponding to the each pH sensor, respectively, and all of the weighted values are summed to generate a weighted data fusion value as the pH value of the sample solution.

The weighted data fusion calculation is further described in the following.

Weighted data fusion calculation:

Standard deviation measures the spread of a collection of numbers about a mean value. A large standard deviation value means that most of the collection of numbers is far from the mean thereof and a small standard deviation value means that most of the collection of numbers is closer to the mean thereof. If the collection of numbers is hypothesized to be xᵢ, x₂, x₃, . . . , xₙ, (all are real numbers), then the mean of the collection of numbers will be:

$$\overline{x} = \frac{1}{n} {\sum }_{i = 1}^{n} {x}_{i} \qquad ( 1 )$$

, where n represents the total of measurement times and xᵢ represents each measurement value.

A standard deviation of a collection of numbers is:

$$σ = \sqrt{\frac{1}{n - 1} {\sum }_{i = 1}^{n} {( {x}_{i} - \overline{x} )}^{2}} \qquad ( 2 )$$

, where n represents the total of measurement times, x₁ represents each measurement value and X̅ represents the mean of the n measurement values generated by each pH sensor.

A condition of m sensors directly measuring a one dimensional target is considered. For different weighted factors of different sensor, in order to minimize the total variance, the weighted factor of each sensor uses a self-adaptive method to search for the best weighted factor to make the \hat{X} value after a data fusion calculation be close to the true value.

It is hypothesized that the variances of the measurements value of the m sensor may be σ₁², σ₂², . . . , σₘ², respectively, the true value to be estimated is X, and the mean of the measurements of each sensor independently is x̅₁, x̅₂, . . . , x̅ₘ, respectively and X is a unbiased estimation, and the weighted factor of each sensor is w₁,w₂, . . . , wₘ, respectively. The value after the data fusion calculation must satisfy the following equations:

$$\begin{matrix}{\sum }_{i = 1}^{m} {w}_{i} = 1 ; \\ and & ( 3 ) \\ \hat{X} = {\sum }_{i = 1}^{m} {w}_{i} {\overline{x}}_{i} & ( 4 )\end{matrix}$$

, wherein the equation (3) is presumed from the unbiased estimation and the total variance after the data fusion will be:

$$\begin{matrix}{σ}^{2} = E [ {( X - \hat{X} )}^{2} ] \\ = E [ {( X - {\sum }_{i = 1}^{m} {w}_{i} {\overline{x}}_{i} )}^{2} ] \\ = E [ {( X {\sum }_{i = 1}^{m} {w}_{i} - {\sum }_{i = 1}^{m} {w}_{i} {\overline{x}}_{i} )}^{2} ] \\ = E [ {\sum }_{i = 1}^{m} {{w}_{i} ( X - {\overline{x}}_{i} )}^{2} ] \\ = {\sum }_{i = 1}^{m} {w}_{i}^{2} {σ}_{i}^{2} .\end{matrix} \qquad ( 5 )$$

As equation (5) shows, the total variance is a pluralistic quadratic function of each weighted factor, and thus the minimum of the total variance exists, consequentially. The minimum of the total variance is obtained by making the weighted factors, w₁, w₂, . . . , wₘ satisfy the extreme value of the pluralistic quadratic function of the equation (4). When the total variance is a minimum value, the weighted factor corresponding to it may be obtained by the lagrange multiplier method, as equation (6) shows:

$${w}_{i} = 1 / {σ}_{i}^{2} {\sum }_{j = 1}^{m} {σ}_{j}^{- 2} ( i = 1 , 2 , … , m ) \qquad ( 6 )$$

, wherein σᵢ represents the standard deviation of the n measurement values generated by a specific pH sensor and σⱼ represents each standard deviation of the n measurement values generated by each pH sensor.

For example, when the number of the sensors is 2 and the total variance is at a minimum value, in order to obtain the best estimate of the target, the most appropriate w₁ is chosen to make the equation (5) the most minimum value, and a partial derivative of w₁ is obtained from the two sides of the equation (6), wherein the partial derivative of wᵢ equal to 0 is obtained as follows::

w₁=σ₂²/(σ₁²+σ₂²), w₂+σ₁²)/(σ₁²+σ₂²) (7).

Therefore, the best estimate of X is:

\hat{X}=w₁ x̅₁+w₂ x̅₂ (8)

, wherein the weighted factors, w₁ and w₂ may be obtained from the equation (7).

The equation (8) shows that the smaller the variance of the measurement values is, the larger the corresponding weighted factors are and the more reliable the measurement values are. On the other hand, the larger the variance of the measurement values is, the smaller the corresponding weighted factors are and the less reliable the measurement values are.

Variance of estimated error is:

\hat{σ}²=E(\tilde{x}²)=k₁²σ₁²+k₂²σ₂²=(σ₁⁻²+σ₂⁻²)⁻¹ (9).

The equation (9) shows that \tilde{σ}²<σᵢ² and i=1, 2, i.e. at a minimum variance. After the data fusion of two sensors, the estimated effect of the two sensors is better than the estimated effect of any one sensor, and thus it increases the accuracy of the sensor.

The weighted factors calculation and result thereof for the pH sensor array with different number of sensors may be obtained from the equation (6), as shown in Table 1.

TABLE 1
The weighted factors calculation and result thereof for
the pH sensor array with 2, 4, 8 sensors, respectively.

| Number | | The equation for obtaining the |
|---|---|---|
| of the | Weighted | weighted factors |
| sensors | factor | (equation (6)) |
| 2 | w₁, | ${w}_{1} = \frac{{σ}_{2}^{2}}{{σ}_{1}^{2} + {σ}_{2}^{2}} ,$ |
| | w₂ | ${w}_{2} = \frac{{σ}_{1}^{2}}{{σ}_{1}^{2} + {σ}_{2}^{2}}$ |
| 4 | w₁, | ${w}_{1} = \frac{{σ}_{2}^{2} {σ}_{3}^{2} {σ}_{4}^{2}}{Δ} ,$ |
| | w₂, | ${w}_{2} = \frac{{σ}_{1}^{2} {σ}_{3}^{2} {σ}_{4}^{2}}{Δ} ,$ |
| | w₃, | ${w}_{3} = \frac{{σ}_{1}^{2} {σ}_{2}^{2} {σ}_{4}^{2}}{Δ} ,$ |
| | w₄ | ${w}_{4} = \frac{{σ}_{1}^{2} {σ}_{2}^{2} {σ}_{3}^{2}}{Δ}$ |
| | | Δ = σ₁²σ₂²σ₃² + σ₁²σ₂²σ₄² + |
| | | σ₁²σ₃²σ₄² + σ₂²σ₃²σ₄² |
| 8 | w₁, | ${w}_{1} = \frac{{σ}_{2}^{2} {σ}_{3}^{2} {σ}_{4}^{2} {σ}_{5}^{2} {σ}_{6}^{2} {σ}_{7}^{2} {σ}_{8}^{2}}{Δ} ,$ |
| | w₂, | ${w}_{2} = \frac{{σ}_{1}^{2} {σ}_{3}^{2} {σ}_{4}^{2} {σ}_{5}^{2} {σ}_{6}^{2} {σ}_{7}^{2} {σ}_{8}^{2}}{Δ} ,$ |
| | w₃, | ${w}_{3} = \frac{{σ}_{1}^{2} {σ}_{2}^{2} {σ}_{4}^{2} {σ}_{5}^{2} {σ}_{6}^{2} {σ}_{7}^{2} {σ}_{8}^{2}}{Δ} ,$ |
| | w₄, | ${w}_{4} = \frac{{σ}_{1}^{2} {σ}_{2}^{2} {σ}_{3}^{2} {σ}_{5}^{2} {σ}_{6}^{2} {σ}_{7}^{2} {σ}_{8}^{2}}{Δ} ,$ |
| | w₅, | ${w}_{5} = \frac{{σ}_{1}^{2} {σ}_{2}^{2} {σ}_{3}^{2} {σ}_{4}^{2} {σ}_{6}^{2} {σ}_{7}^{2} {σ}_{8}^{2}}{Δ} ,$ |
| | w₆, | ${w}_{6} = \frac{{σ}_{1}^{2} {σ}_{2}^{2} {σ}_{3}^{2} {σ}_{4}^{2} {σ}_{5}^{2} {σ}_{7}^{2} {σ}_{8}^{2}}{Δ} ,$ |
| | w₇, | ${w}_{7} = \frac{{σ}_{1}^{2} {σ}_{2}^{2} {σ}_{3}^{2} {σ}_{4}^{2} {σ}_{5}^{2} {σ}_{6}^{2} {σ}_{8}^{2}}{Δ} ,$ |
| | w₈ | ${w}_{8} = \frac{{σ}_{1}^{2} {σ}_{2}^{2} {σ}_{3}^{2} {σ}_{4}^{2} {σ}_{5}^{2} {σ}_{6}^{2} {σ}_{7}^{2}}{Δ}$ |
| | | $Δ = {\prod }_{\begin{matrix}j = 1 \\ j \neq i\end{matrix}}^{8} {σ}_{j}^{2} / {\sum }_{s = 1}^{8} {\prod }_{\begin{matrix}j = 1 \\ j \neq s\end{matrix}}^{8} {σ}_{j}^{2} , i = 1 , … , 8$ |

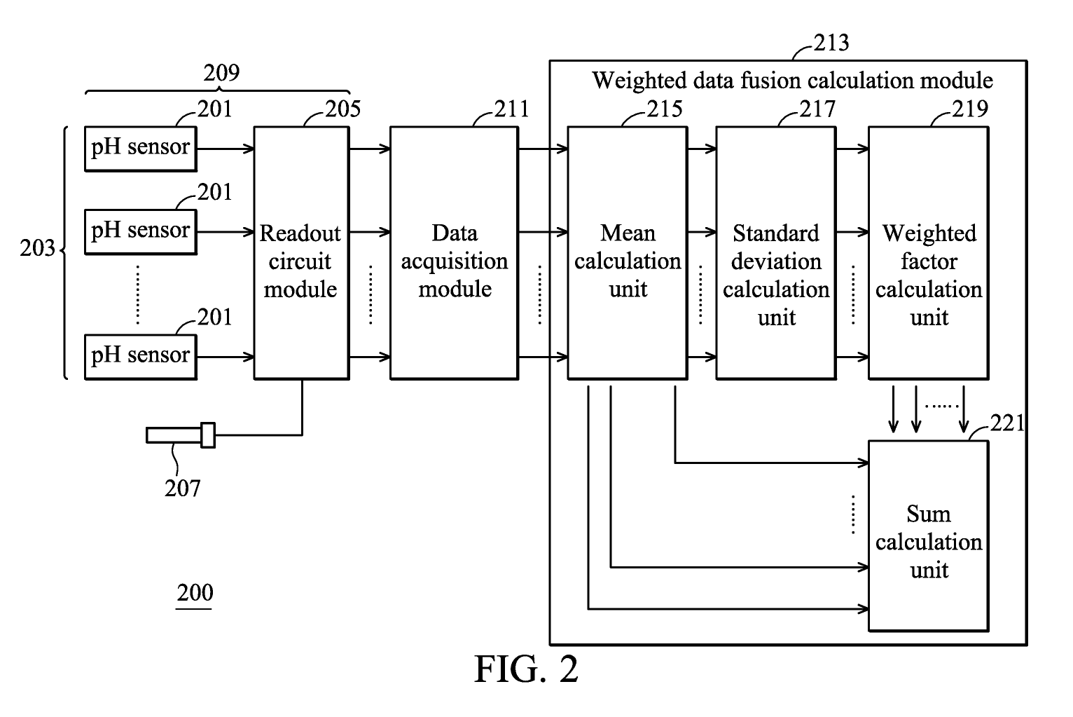

The invention also provides a pH value measurement system, as shown in FIG. 2. As shown in FIG. 2, a pH value measurement system 200 may comprise a pH sensing device 209, a data acquisition module 211 and a weighted data fusion calculation module 213. The pH sensing device 209 may comprise a pH sensor array 203 comprising a plurality of pH sensors 203, a readout circuit module 205 coupled to the pH sensor 203 and a reference electrode 207 coupled to the readout circuit module for providing a stable voltage. A sample solution is measured with the pH sensor array 203 for n times, and n is an integer greater than 1. Each pH sensor 201 generates a measurement value for each measurement and each pH sensor 201 generates n signals. The readout circuit module 205 is used for receiving the n signals generated by each pH sensor 201. Moreover, the plurality of pH sensors may comprise 2, 4 or 8 pH sensors.

In one embodiment, the pH sensor 201 may comprise a ruthenium dioxide pH sensor. A ruthenium dioxide pH sensor 100 may comprise a substrate 101, a ruthenium dioxide layer 103, a metal wire 105, and a protective layer 107. The ruthenium dioxide layer 103 on the substrate 101 forms a sensing region, the metal wire 105 fixed on a surface on the ruthenium dioxide layer 103 forms an external contact and the protective layer 107 is over the ruthenium dioxide layer 103 having a opening for a sensing window 109 (Referring to FIG. 1). In one embodiment, the reference electrode 207 may comprise an Ag/AgCl reference electrode.

The data acquisition module 211 is coupled to the readout circuit module 205 for converting the n signals generated by each pH sensor into n measurement values measured by each pH sensor. The weighted data fusion calculation module 213 is coupled to the data acquisition module 211 for performing a weighted data fusion calculation with all of the measurement values converted by the data acquisition module 211 to generate a pH value of the sample solution.

Furthermore, the weighted data fusion calculation module 213 may comprise a mean calculation unit 215, a standard deviation calculation unit 217, a weighted factor calculation unit 219 and a sum calculation unit 221. The mean calculation unit 215 is coupled to the data acquisition module 211 for calculating a mean of the n measurement values converted by the data acquisition module 211 from the n signals generated by each pH sensor. The standard deviation calculation unit 217 is coupled to the mean calculation unit 215 for generating a standard deviation of the n measurement values with the n measurement values and the mean of the n measurement values. The weighted factor calculation unit 219 is coupled to the standard deviation calculation unit 217 for generating a weighted factor corresponding to the respective pH sensor with all the standard deviations. The sum calculation unit 221 is coupled to the mean calculation unit 215 and the weighted factor calculation unit 219 for multiplying the mean of the n measurement values of the respective pH sensor with the weighted factor corresponding to the respective pH sensor to generate a weighted value and summing all of the weighted values to generate a weighted data fusion value as the pH value of the sample solution.

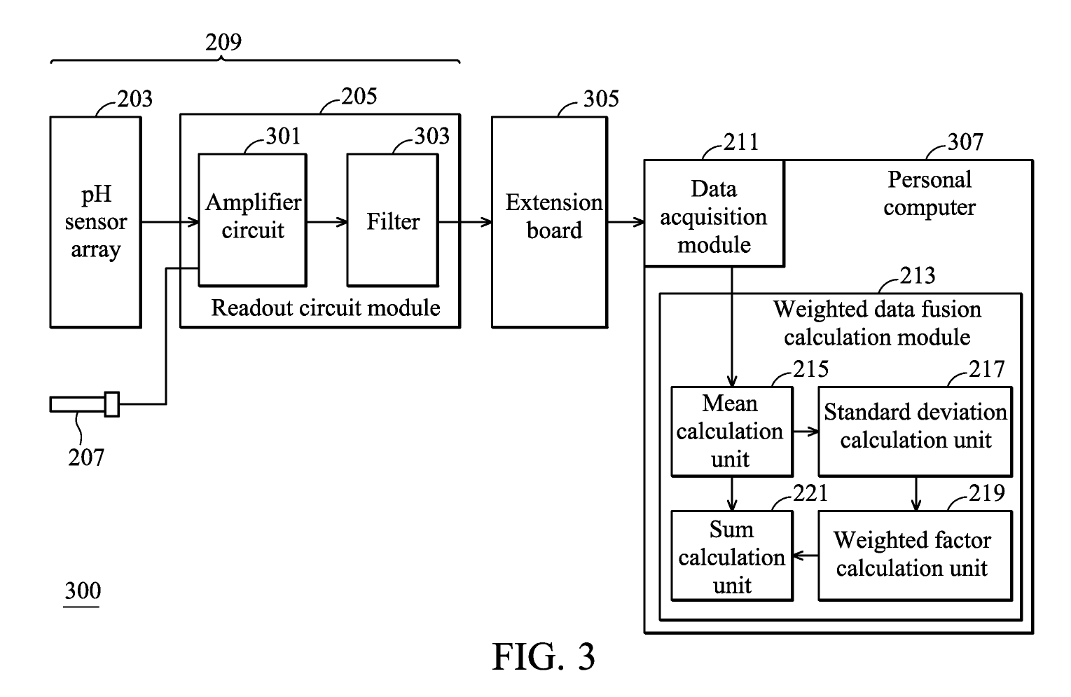

In another embodiment, the data acquisition module 211 and the weighted data fusion calculation module 213 may be in a personal computer 307, as shown in FIG. 3.

Referring to FIG. 3, a pH value measurement system 300 may further comprise an extension board 305, and the readout circuit module 205 may further comprise an amplifier circuit 301 and a filter 303. The amplifier circuit 301 is between the pH sensor array and the filter 303 for amplifying the signal from the pH sensor array 203. In addition, the filter 303 is used for filtering a noise. Moreover, the extension board 305 between the readout circuit module 205 and the personal computer 307 is used for coupling the filter 303 to the data acquisition module 211.

### Example

### Example 1

Measuring the pH Vale of a Sample Solution by the Sensor Array with Different Number of the Sensors, Respectively

In order to confirm the feasibility of using a weighted data fusion calculation in a sensor array, the sensor arrays with 2, 4 or 8 sensors were used to measure the pH value of a sample solution. The simulation data of the weighted data fusion and the measuring results are shown in Table 2.

TABLE 2
Weighted data fusion calculation results of measurement values measured by the sensor array with 2, 4 or 8 sensors

| Number | | | | | | | | | | | | | Weighted | | Average | Weighted |
|---|---|---|---|---|---|---|---|---|---|---|---|---|---|---|---|---|
| of the | | Simulation data (n = 10) | | | | | | | | | | Variance | factor | | data | data |
| sensors (i) | | (pH = 7) | | | | | | | | | | (σᵢ²) | (wᵢ) | Mean | fusion | fusion |
| 2 | (1) | 7.12 | 7.14 | 6.99 | 7.05 | 7.06 | 7.00 | 7.10 | 6.98 | 6.99 | 7.00 | 0.003579 | 0.965904 | 7.043 | 6.917 | 7.0344 |
| | (2) | 6.65 | 6.71 | 7.09 | 6.80 | 7.11 | 6.10 | 6.95 | 6.50 | 7.10 | 6.90 | 0.101388 | 0.034096 | 6.791 | (0.083) | (0.0344) |
| 4 | (1) | 7.12 | 7.14 | 6.99 | 7.05 | 7.06 | 7.00 | 7.10 | 6.98 | 6.99 | 7.00 | 0.003579 | 0.699775 | 7.043 | 6.859 | 7.04312 |
| | (2) | 6.65 | 6.71 | 7.09 | 6.80 | 7.11 | 6.10 | 6.95 | 6.50 | 7.10 | 6.90 | 0.101388 | 0.024702 | 6.791 | (0.141) | (0.04312) |
| | (3) | 7.11 | 7.12 | 7.09 | 6.99 | 7.04 | 7.20 | 7.30 | 7.10 | 7.00 | 7.00 | 0.009561 | 0.261949 | 7.095 | | |
| | (4) | 6.01 | 6.32 | 6.81 | 6.08 | 6.12 | 6.80 | 6.08 | 6.78 | 6.87 | 7.20 | 0.184512 | 0.013574 | 6.507 | | |
| 8 | (1) | 7.12 | 7.14 | 6.99 | 7.05 | 7.06 | 7.00 | 7.10 | 6.98 | 6.99 | 7.00 | 0.003579 | 0.014621 | 7.043 | 6.98025 | 7.00048 |
| | (2) | 6.65 | 6.71 | 7.09 | 6.80 | 7.11 | 6.10 | 6.95 | 6.50 | 7.10 | 6.90 | 0.101388 | 0.000516 | 6.791 | (0.01975) | (0.00048) |
| | (3) | 7.11 | 7.12 | 7.09 | 6.99 | 7.04 | 7.20 | 7.30 | 7.10 | 7.00 | 7.00 | 0.009561 | 0.005473 | 7.095 | | |
| | (4) | 6.01 | 6.32 | 6.81 | 6.08 | 6.12 | 6.80 | 6.08 | 6.78 | 6.87 | 7.20 | 0.184512 | 0.000284 | 6.507 | | |
| | (5) | 7.00 | 7.00 | 7.00 | 7.01 | 6.99 | 7.00 | 6.99 | 6.99 | 7.00 | 7.01 | 0.000054 | 0.969018 | 6.999 | | |
| | (6) | 6.80 | 6.70 | 6.85 | 6.58 | 6.67 | 6.50 | 6.80 | 6.58 | 6.90 | 6.60 | 0.018018 | 0.002904 | 6.698 | | |
| | (7) | 7.22 | 7.13 | 7.34 | 7.09 | 7.21 | 7.10 | 7.20 | 7.21 | 7.31 | 7.11 | 0.007418 | 0.007054 | 7.192 | | |
| | (8) | 7.23 | 6.90 | 8.01 | 6.98 | 6.75 | 6.80 | 8.20 | 8.00 | 8.10 | 8.20 | 0.400334 | 0.000131 | 7.517 | | |

As the results show in Table 2, the weighted data fusion result for the measurement values was better than the mean of measurement values for a single sensor and the average data fusion result for the measurement values (the average of the means of the measurement values for each sensor).

### Example 2

The Sensitivity Test for a Sensor Array to the Different Sample Solutions with Different pH Values

(1) pH Value Measurement of the Buffer Solutions by a Sensor Array

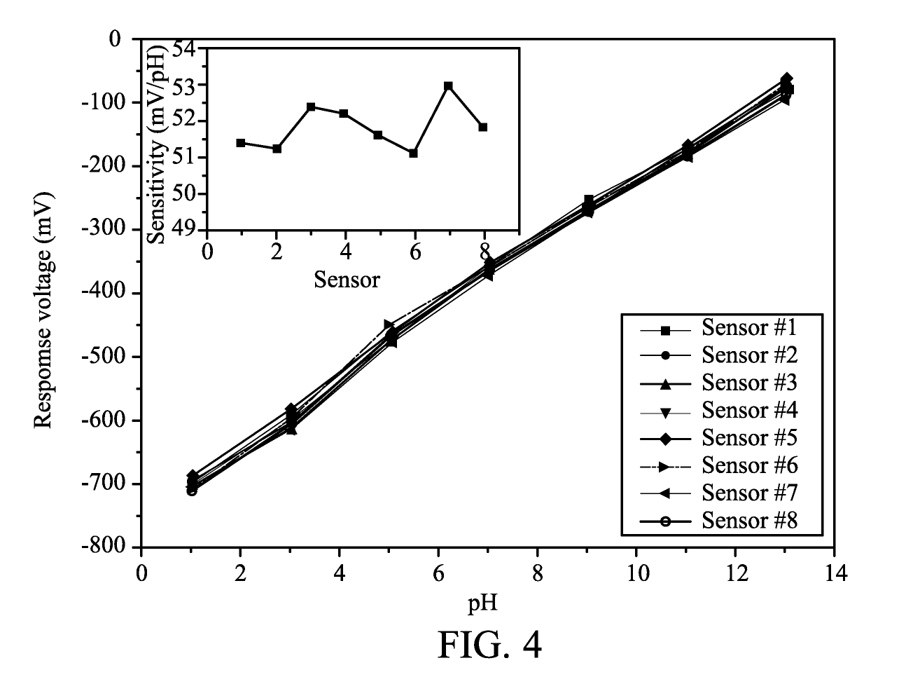

By using a pH value measurement system, a pH sensor array formed by 8 ruthenium dioxide pH sensors, and an Ag/AgCl reference electrode were dipped into the different buffer solutions with pH values of 1, 3, 5, 7, 9, 11 and 13, respectively and the response voltages for the different buffer solutions were recoded, respectively. The sensitivity of the pH sensor array for the different buffer solutions with different pH values were obtained according to the linear relationship between the response voltage and the pH value. The result is shown in FIG. 4.

### Example 3

pH Value Measurement of Different Sample Solutions by a Sensor Array

(1) Measuring the pH Value of Wine by a Sensor Array

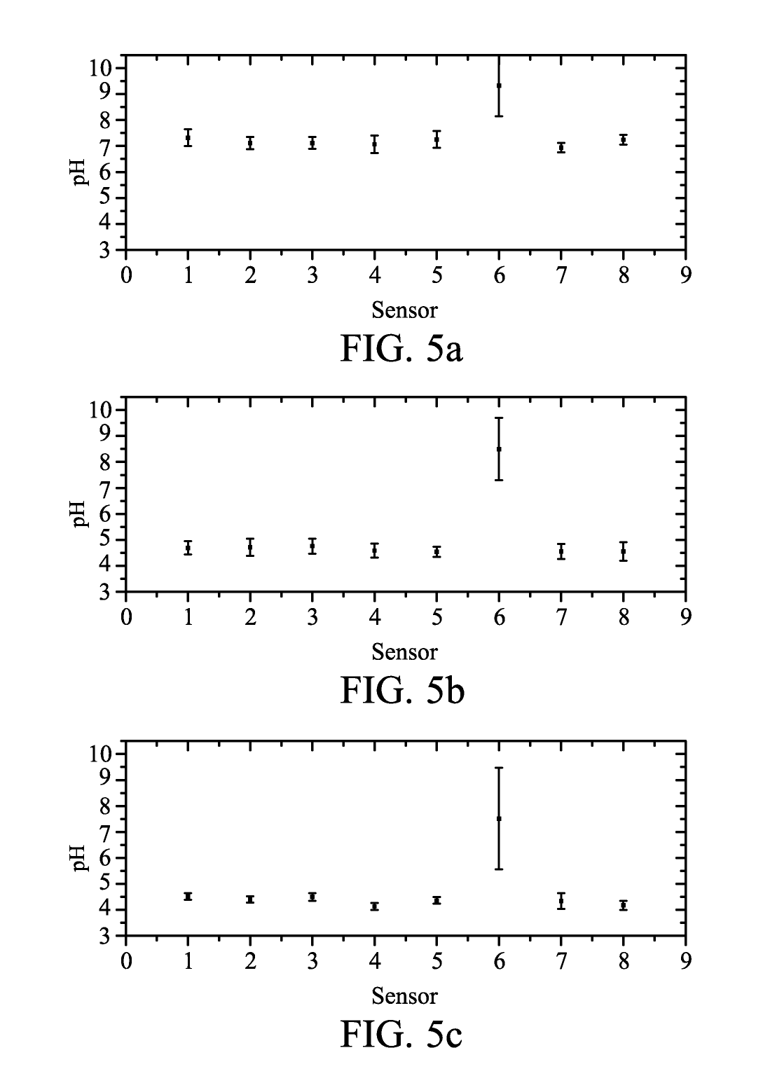

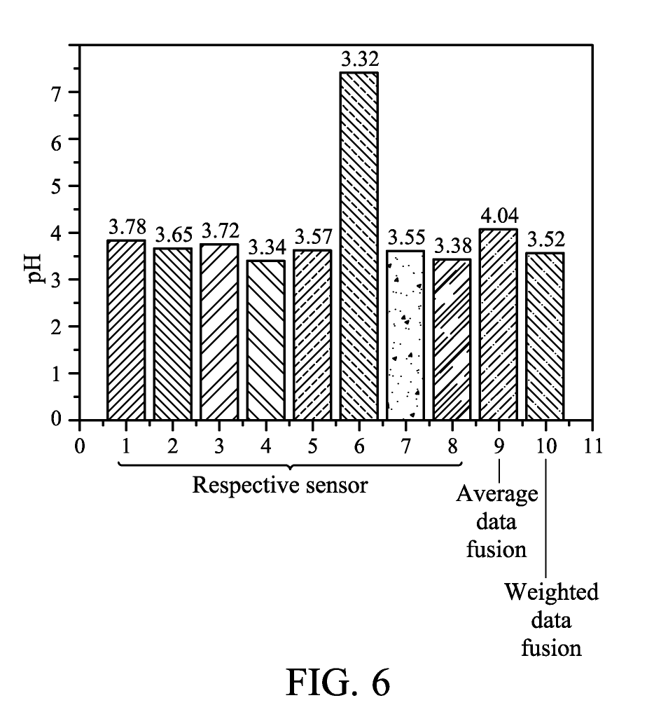

The pH value of wine was measured by a pH sensor array formed by 8 ruthenium dioxide pH sensors. The pH sensor array generated 8 measurement values for each measurement and the measurement was repeated for 10 times. The mean calculation, standard deviation calculation, average data fusion calculation and weighted data fusion calculation were performed with the obtained measurement values, respectively. The results are shown in Table 3, FIG. 5a and FIG. 6.

(2) Measuring the pH Value of Coca Cola by a Sensor Array

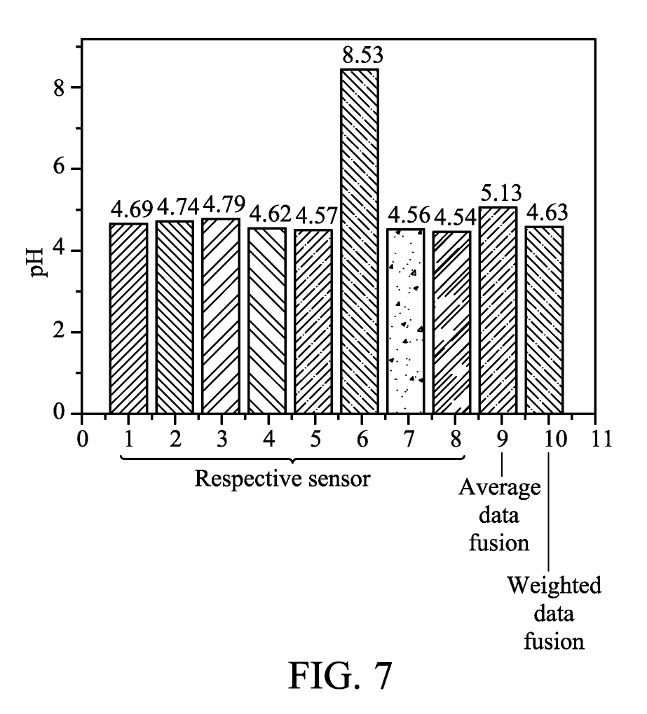

The pH value of the coca cola was measured by a pH sensor array formed by 8 ruthenium dioxide pH sensors. The pH sensor array generated 8 measurement values for each measurement and the measurement was repeated for 10 times. The mean calculation, standard deviation calculation, average data fusion calculation and weighted data fusion calculation were performed with the obtained measurement values, respectively. The results are shown in Table 4, FIG. 5b and FIG. 7.

(3) Measuring the pH Value of an Alkaline Water Drink by a Sensor Array

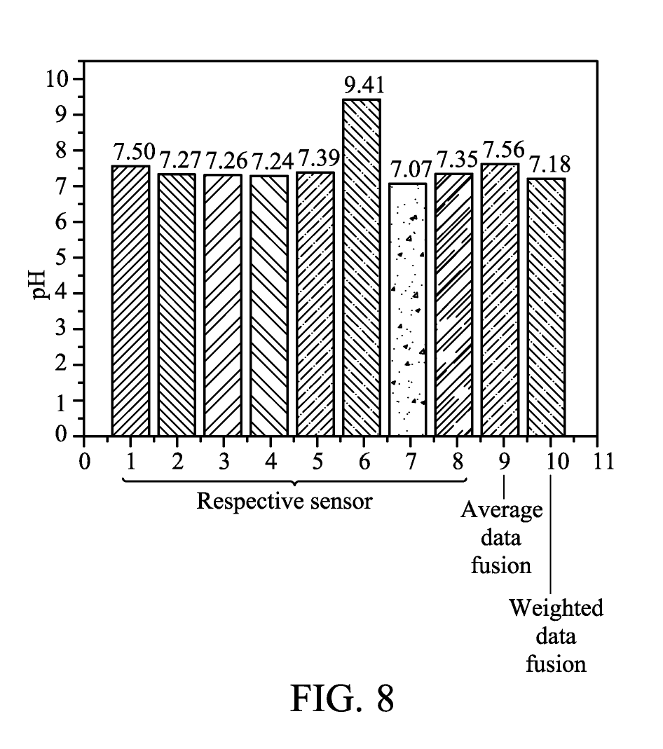

The pH value of an alkaline water drink (Uni-president, pH 9.0 plus deep ocean water) was measured by a pH sensor array formed by 8 ruthenium dioxide pH sensors. The pH sensor array generated 8 measurement values for each measurement and the measurement was repeated for 10 times. The mean calculation, standard deviation calculation, average data fusion calculation and weighted data fusion calculation were performed with the obtained measurement values, respectively. The results are shown in Table 5, FIG. 5c and FIG. 8.

### Example 4

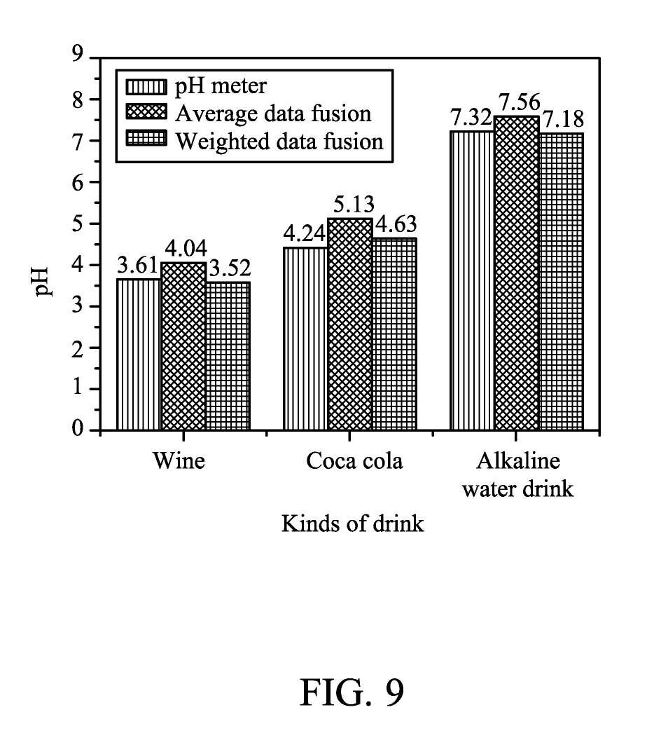

The average data fusion result and weighted data fusion result of the measurement values of wine, coca cola and the alkaline water drink by the pH value measurement system were compared with the measurement values of wine, coca cola and the alkaline water drink by a pH meter. The results are shown in FIG. 9.

FIG. 9 shows that the weighted data fusion result is closer to the result measured by the pH meter than the average data fusion result.

Furthermore, as FIGS. 6-9 show, when using the method and the pH value measurement system of the invention, there was minimal error in the pH value measurement result when a sensor failed during measurement of a sample solution.

TABLE 3
pH values of wine measured by a sensor array and the weighted data fusion results therefrom

| Number | | | | | | | | | | | | | Weighted | | Average | Weighted |
|---|---|---|---|---|---|---|---|---|---|---|---|---|---|---|---|---|
| of the | | | | | | | | | | | | | factor | | data | data |
| sensors (i) | | Measured data (n = 10) | | | | | | | | | | Variance (σᵢ²) | (wᵢ) | Mean | fusion | fusion |
| Wine | (1) | 3.954 | 3.884 | 3.742 | 3.674 | 3.796 | 3.595 | 3.588 | 3.619 | 4.050 | 3.884 | 0.000680 | 0.031583 | 3.779 | 4.037 | 3.520 |
| | (2) | 3.802 | 3.540 | 3.555 | 3.710 | 3.785 | 3.597 | 3.562 | 3.457 | 3.806 | 3.642 | 0.000235 | 0.091279 | 3.645 | | |
| | (3) | 3.758 | 3.695 | 3.615 | 3.733 | 3.819 | 3.652 | 3.524 | 3.489 | 3.977 | 3.925 | 0.000640 | 0.033559 | 3.719 | | |
| | (4) | 3.315 | 3.318 | 3.256 | 3.380 | 3.565 | 3.290 | 3.241 | 3.275 | 3.403 | 3.340 | 0.000081 | 0.266276 | 3.338 | | |
| | (5) | 3.496 | 3.488 | 3.557 | 3.572 | 3.770 | 3.564 | 3.552 | 3.529 | 3.612 | 3.554 | 0.000040 | 0.542853 | 3.569 | | |
| | (6)* | 4.590 | 4.304 | 5.608 | 5.136 | 8.616 | 10.444 | 10.051 | 9.398 | 7.952 | 7.071 | 28.347241 | 0.000001 | 7.317 | | |
| | (7) | 3.595 | 3.557 | 3.430 | 3.290 | 3.266 | 3.232 | 3.198 | 4.154 | 3.950 | 3.800 | 0.011773 | 0.001824 | 3.547 | | |
| | (8) | 3.679 | 3.539 | 3.530 | 3.421 | 3.310 | 3.212 | 3.176 | 3.325 | 3.284 | 3.309 | 0.000658 | 0.032625 | 3.379 | | |

*Sensor fail, measured value of pH meter: 3.61.

TABLE 4
pH values of coca cola measured by a sensor array and the weighted data fusion results therefrom

| Number of | | | | | | | | | | | | | Weighted | | Average | Weighted |
|---|---|---|---|---|---|---|---|---|---|---|---|---|---|---|---|---|
| the sensors | | | | | | | | | | | | Variance | factor | | data | data |
| (i) | | Measured data (n = 10) | | | | | | | | | | (σᵢ²) | (wᵢ) | Mean | fusion | fusion |
| Coca | (1) | 4.177 | 4.470 | 4.546 | 5.105 | 4.725 | 4.747 | 4.778 | 4.796 | 4.771 | 4.786 | 0.003646 | 0.179514 | 4.690 | 5.130 | 4.629 |
| cola | (2) | 4.067 | 4.364 | 4.520 | 4.941 | 4.850 | 4.806 | 4.824 | 4.855 | 5.141 | 5.073 | 0.012109 | 0.054055 | 4.744 | | |
| | (3) | 4.151 | 4.521 | 4.633 | 4.938 | 4.878 | 4.863 | 4.899 | 4.961 | 4.874 | 5.129 | 0.006094 | 0.107406 | 4.785 | | |
| | (4) | 3.980 | 4.339 | 4.602 | 4.582 | 4.700 | 4.772 | 4.891 | 4.760 | 4.742 | 4.787 | 0.005306 | 0.123370 | 4.615 | | |
| | (5) | 4.083 | 4.354 | 4.540 | 4.630 | 4.648 | 4.639 | 4.665 | 4.712 | 4.705 | 4.735 | 0.001724 | 0.379742 | 4.571 | | |
| | (6)* | 5.832 | 8.037 | 9.009 | 7.219 | 8.387 | 9.119 | 9.523 | 9.463 | 9.357 | 9.351 | 2.103199 | 0.000311 | 8.530 | | |
| | (7) | 3.976 | 4.315 | 4.402 | 4.426 | 4.879 | 4.724 | 4.743 | 4.608 | 4.721 | 4.794 | 0.005851 | 0.111878 | 4.559 | | |
| | (8) | 3.823 | 4.163 | 4.261 | 4.582 | 4.554 | 4.815 | 4.853 | 4.787 | 4.793 | 4.796 | 0.014970 | 0.043724 | 4.543 | | |

*Sensor fail, measured value of pH meter: 4.24.

TABLE 5
pH values of an alkaline water drink measured by a sensor array and the weighted data fusion results therefrom

| Number of | | | | | | | | | | | | | Weighted | | Average | Weighted |
|---|---|---|---|---|---|---|---|---|---|---|---|---|---|---|---|---|
| the sensors | | | | | | | | | | | | Variance | factor | | data | data |
| (i) | | Measured data (n = 10) | | | | | | | | | | (σᵢ²) | (wᵢ) | Mean | fusion | fusion |
| Alkaline | (1) | 7.579 | 7.172 | 7.655 | 7.912 | 6.972 | 7.161 | 7.297 | 7.906 | 7.610 | 7.700 | 0.011354 | 0.020605 | 7.496 | 7.560 | 7.181 |
| water | (2) | 7.671 | 6.987 | 7.527 | 7.127 | 7.091 | 7.091 | 7.113 | 7.356 | 7.408 | 7.279 | 0.002413 | 0.096968 | 7.265 | | |
| drink | (3) | 6.913 | 7.391 | 7.584 | 7.108 | 7.128 | 7.279 | 7.314 | 7.269 | 7.227 | 7.427 | 0.001231 | 0.190088 | 7.264 | | |
| | (4) | 7.732 | 7.050 | 7.807 | 7.386 | 6.913 | 6.982 | 7.135 | 7.247 | 6.981 | 7.142 | 0.009627 | 0.024300 | 7.238 | | |
| | (5) | 7.769 | 7.249 | 7.999 | 7.533 | 7.035 | 6.993 | 7.134 | 7.375 | 7.343 | 7.471 | 0.010293 | 0.022729 | 7.390 | | |
| | (6)* | 9.583 | 8.392 | 10.321 | 11.541 | 10.183 | 9.377 | 8.756 | 9.113 | 8.578 | 8.298 | 1.109699 | 0.022729 | 9.414 | | |
| | (7) | 7.152 | 6.813 | 7.053 | 7.161 | 6.999 | 7.080 | 7.149 | 7.081 | 6.870 | 7.313 | 0.000455 | 0.514522 | 7.067 | | |
| | (8) | 7.568 | 7.097 | 7.315 | 7.632 | 7.445 | 7.221 | 7.362 | 7.577 | 7.182 | 7.062 | 0.001792 | 0.130577 | 7.346 | | |

*Sensor fail, measured value of pH meter: 7.32.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for measuring a pH value of a sample solution, which is performed by a pH sensing device, comprising:
providing a pH sensing device and a sample solution, wherein the pH sensing device comprises a pH sensor array, and the pH sensor array comprises m pH sensors, and m is an integer greater than 1;
measuring the sample solution with the pH sensor array for n times, wherein n is an integer greater than 1, n measurement values are generated, each pH sensor generates a measurement value for each measurement, and the total amount of measurement values generated is n×m; and
generating a pH value of the sample solution by all of the measurement values generated by the pH sensor array.

2. The method for measuring a pH value of a sample solution as claimed in claim 1, 2 wherein the pH sensor comprises a ruthenium dioxide pH sensor.

3. The method for measuring a pH value of a sample solution as claimed in claim 2, wherein the ruthenium dioxide pH sensor comprises:
a substrate;
a ruthenium dioxide layer on the substrate to form a sensing region;
a metal wire fixed on a surface on the ruthenium dioxide layer; and
a protective layer over the ruthenium dioxide layer having a opening for a sensing window.

4. The method for measuring a pH value of a sample solution as claimed in claim 1, wherein a manner for measuring the sample solution with the pH sensor array comprises contacting the sample solution with each pH sensor.

5. The method for measuring a pH value of a sample solution as claimed in claim 3, wherein a manner for measuring the sample solution with the pH sensor array comprises contacting the sample solution with the sensing window.

6. The method for measuring a pH value of a sample solution as claimed in claim 1, wherein m is 2, 4 or 8.

7. The method for measuring a pH value of a sample solution as claimed in claim 1, wherein a method for generating the pH value of the sample solution by all of the measurement values generated by the pH sensor array comprises performing a weighted data fusion calculation of all of the measurement values generated by the pH sensor array to generate a weighted data fusion value as the pH value of the sample solution.

8. The method for measuring a pH value of a sample solution as claimed in claim 7, wherein the weighted data fusion calculation comprises:
(a) calculating a mean of the n measurement values generated by each pH sensor, respectively, wherein the total amount of means generated is m;
(b) generating a standard deviation of the n measurement values generated by each pH sensor with the n measurement values generated by each pH sensor and the mean of the n measurement generated by each pH sensor, wherein the total amount of standard deviations generated is m;
(c) generating a weighted factor corresponding to each pH sensor with all the standard deviations, wherein the total amount of weighted factors generated is m; and
(d) generating a weighted value by multiplying the mean of the n measurement values generated by the each pH sensor with the weighted factor corresponding to the each pH sensor, respectively, and summing all of the weighted values to generate a weighted data fusion value as the pH value of the sample solution.

9. The method for measuring a pH value of a sample solution as claimed in claim 8, wherein in the step (a), the mean of the n measurement values generated by each pH sensor is
$$\overline{x} = \frac{1}{n} {\sum }_{i = 1}^{n} {x}_{i} ,$$
where n represents the total of measurement times and xᵢ represents each measurement value.

10. The method for measuring a pH value of a sample solution as claimed in claim 8, wherein in the step (b), the standard deviation of the n measurement values generated by each pH sensor is
$$σ = \sqrt{\frac{1}{n - 1} {\sum }_{i = 1}^{n} {( {x}_{i} - \overline{x} )}^{2}} ,$$
where n represents the total of measurement times, x₁ represents each measurement value and X̅ represents the mean of the n measurement values generated by each pH sensor.

11. The method for measuring a pH value of a sample solution as claimed in claim 8, wherein in the step (c), the weighted factor corresponding to each pH sensor is
$${w}_{i} = 1 / {σ}_{i}^{2} {\sum }_{j = 1}^{m} {σ}_{j}^{- 2} ( i = 1 , 2 , … , m ) ,$$
wherein σᵢ represents the standard deviation of the n measurement values generated by a specific pH sensor and σⱼ represents each standard deviation of the n measurement values generated by each pH sensor.

12. The method for measuring a pH value of a sample solution as claimed in claim 8, wherein in the step (d), the weighted data fusion value is
$$\hat{X} = {\sum }_{i = 1}^{m} {w}_{i} {\overline{x}}_{i} ,$$
wherein wᵢ represents each weighted factor corresponding to each pH sensor and x̅ᵢ represents each mean of the n measurement values generated by each pH sensor.

13. A pH value measurement system, comprising:
a pH sensing device, comprising:
a pH sensor array comprising a plurality of pH sensors, wherein a sample solution is measured with the pH sensor array for n times, and n is an integer greater than 1, and each pH sensor generates a measurement value for each measurement and each pH sensor generates n signals;
a readout circuit module coupled to the pH sensor array for receiving the n signals generated by each pH sensor; and
a reference electrode coupled to the readout circuit module for providing a stable voltage;
a data acquisition module coupled to the readout circuit module for converting the n signals generated by each pH sensor into n measurement values measured by each pH sensor; and
a weighted data fusion calculation module coupled to the data acquisition module for performing a weighted data fusion calculation with all of the measurement values converted by the data acquisition module to generate a pH value of the sample solution.

14. The pH value measurement system as claimed in claim 13, wherein the plurality of pH sensors comprise 2, 4 or 8 pH sensors.

15. The pH value measurement system as claimed in claim 13, wherein the pH sensor comprises a ruthenium dioxide pH sensor.

16. The pH value measurement system as claimed in claim 15, wherein the ruthenium dioxide pH sensor comprises:
a substrate;
a ruthenium dioxide layer on the substrate to form a sensing region;
a metal wire fixed on a surface on the ruthenium dioxide layer; and
a protective layer over the ruthenium dioxide layer having a opening for a sensing window.

17. The pH value measurement system as claimed in claim 13, wherein the reference electrode comprises an Ag/AgCl reference electrode.

18. The pH value measurement system as claimed in claim 13, wherein the weighted data fusion calculation module comprises:
a mean calculation unit coupled to the data acquisition module for calculating a mean of the n measurement values converted by the data acquisition from the n signals generated by each pH sensor;
a standard deviation calculation unit coupled to the mean calculation unit for generating a standard deviation of the n measurement values with the n measurement values and the mean of the n measurement values;
a weighted factor calculation unit coupled to the standard deviation calculation unit for generating a weighted factor corresponding to the respective pH sensor with all the standard deviations; and
a sum calculation unit coupled to the mean calculation unit and the weighted factor calculation unit for multiplying the mean of the n measurement values of the respective pH sensor with the weighted factor corresponding to the respective pH sensor to generate a weighted value and summing all of the weighted values to generate a weighted data fusion value as the pH value of the sample solution.

19. The pH value measurement system as claimed in claim 13, wherein the data acquisition module and the weighted data fusion calculation module are in a personal computer.

20. The pH value measurement system as claimed in claim 19, wherein the readout circuit module further comprises:
a filter for filtering a noise; and
an amplifier circuit coupled to and between the pH sensor array and the filter for amplifying the signal from the pH sensor array.

21. The pH value measurement system as claimed in claim 20, further comprising an extension board between the readout circuit module and the personal computer for coupling the filter to the data acquisition module.
